(19) United States
(12) Patent Application Publication
(10) Pub. No.: US 2006/0104474 A1
(43) Pub. Date: May 18, 2006

(54) Method, apparatus and system for authenticating images by digitally signing hidden messages near the time of image capture

(76) Inventor: Raja Neogi, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/987,345

(22) Filed: Nov. 12, 2004

(51) Int. Cl. G06K 9/00

(52) U.S. Cl. 382/100

(57) ABSTRACT

Apparatus, systems and methods for authenticating images by digitally signing hidden messages near to the time of image capture are disclosed. In one implementation, a system includes an image data source and processing logic responsive to the image data source. The processing logic being capable of quantizing transformed image data blocks to generate encoded image data blocks and embedding a message within one or more of the encoded image data blocks by modulating one or more zero valued frequency coefficients. The processing logic may also be capable of generating metadata specifying at least the one or more zero valued frequency coefficients modulated to embed the message.

### BACKGROUND

High resolution digital images (e.g., images containing five million or more individual pixels) may be generated in a variety of contexts including, but not limited to, surveillance and/or reconnaissance imaging. While improvements in image capture, enhancement and storage technologies have made high resolution imaging more affordable such images may be easily manipulated after capture. Because digital images are so easily altered, methods are needed to authenticate image content. Authentication protects the image consumer by guaranteeing the originality of the image content. To minimize the risk of image content modification an image should be authenticated as early as possible.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an example system;

FIGS. 2A-B illustrate portions of the system of FIG. 1 in more detail;

FIG. 3 is a flow chart illustrating an example process for authenticating image data;

FIGS. 4A-C are flow charts illustrating portions of the process of FIG. 3 in more detail; and,

FIGS. 5A-B illustrate portions of an example image data array including zerotree image coefficients.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art, having the benefit of the present disclosure, that the various aspects of the invention claimed may be practiced in other examples that depart from these specific details. In certain instances, descriptions of well known devices, circuits, and methods are omitted so as not to obscure the description of the present invention with unnecessary detail.

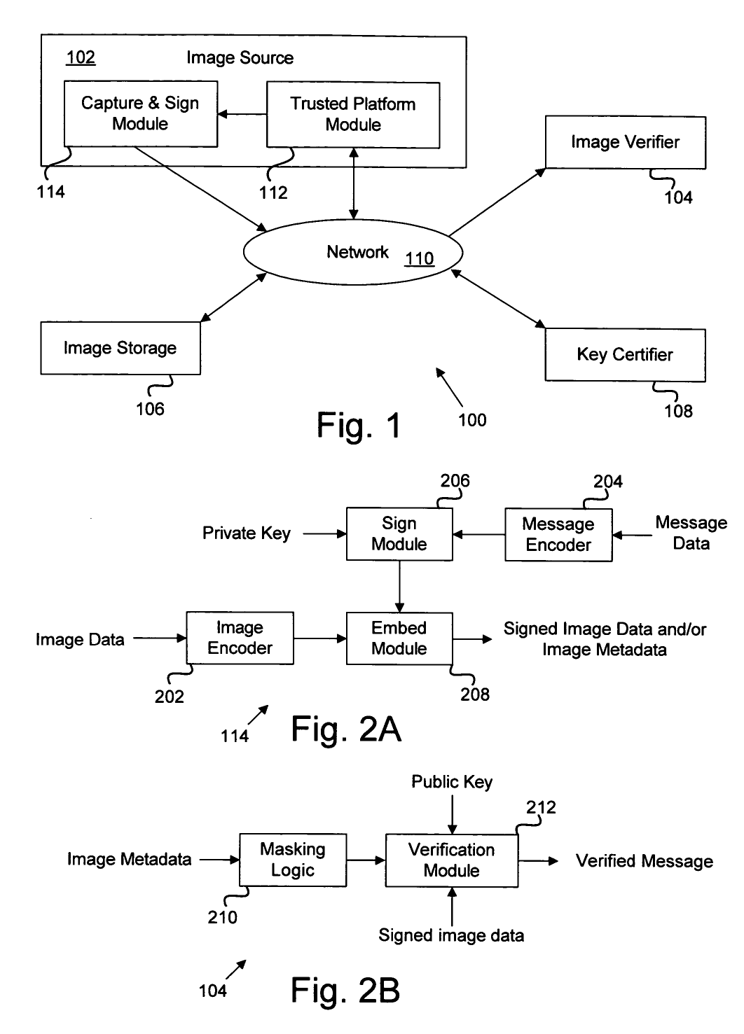

FIG. 1 illustrates an example system 100 according to one implementation of the invention. System 100 may include an image source 102, at least one image verifier 104, image storage 106 and a key certifier 108. Image source 102, verifier 104, storage 106 and certifier 108 may be communicatively coupled with each other through a network 110. In one implementation, image source 102 may include a trusted platform module (TPM) 112 and a capture and sign module (CSM) 114.

Image source 102 may be any imaging source capable of generating or providing image data in accordance with the invention. For example, source 102 may be a digital camera capable of capturing high-resolution images (e.g., images having five million or more pixel values) although the invention is not limited in this regard. For example, in one implementation, image source 102 may comprise a mobile computer coupled through a private network (not shown) to receive image data from a remote camera (not shown). These are merely examples, however, and many other implementations of image source 102 are consistent with the scope of the invention as disclosed herein. While those of skill in the art will recognize that image source 102 may include additional elements such as an imaging array, lens, memory etc. not shown in FIG. 1, such elements do not necessarily limit the invention and have been excluded from FIG. 1 and associated descriptions so as to not obscure the various aspects of the invention.

In one implementation, image source 102 may be capable of generating a message in the form of audio and/or text data that may be used to authenticate image data. In one implementation, source 102 may generate audio data from one or more microphones (not shown) associated with source 102 that may capture audio information from the environment surrounding source 102, although the invention is not limited in this regard and the audio data may be voice audio provided to source 102. Source 102 may also generate text data in the form of temporal and spatial location reference parameters such as time, date and/or location of image data capture, to name a few examples. Overall, the invention is not limited in regard to the types of data included in the message and any combination of audio and/or text data and/or other data may be supplied to, generated by and/or captured by source 102 in accordance with the invention as disclosed herein.

In one implementation, source 102 may compress the audio and/or text message data to generate an encoded message using a Code Excited Linear Prediction Model (CELP) coding scheme as provided in International Telecommunication Union (ITU) Recommendation ITU-T G.729 (1996), although the invention is not limited in this regard and other schemes of encoding the message may be utilized in accordance with the invention. In another implementation source 102 may be provided with a message and/or an encoded message generated remotely from source 102.

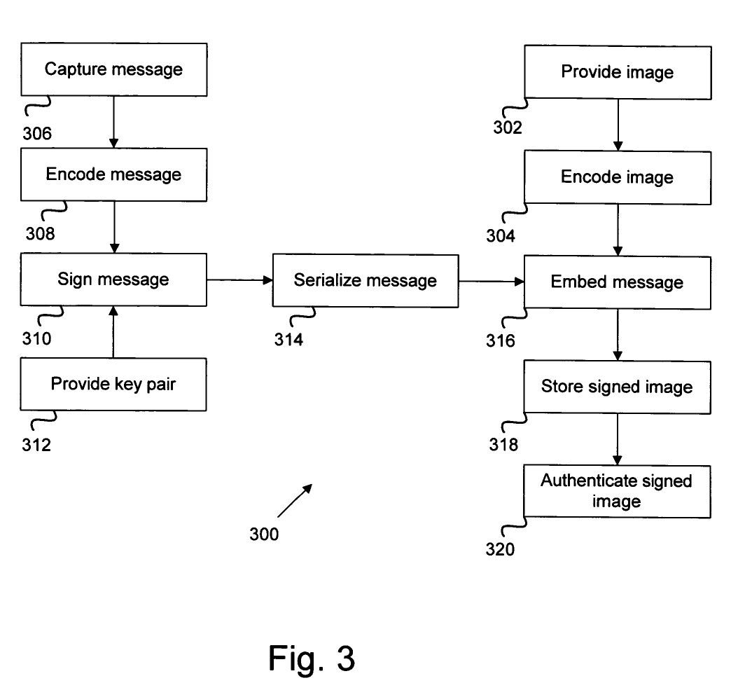

In one implementation, TPM 112 may be a reduced form factor TPM capable of generating and/or storing certified key pairs as described in more detail below with regard to FIG. 2A and FIG. 3. TPM 112 may have a reduced form factor so that it can be conveniently packaged within image source 102, although the invention is not limited in this regard, and TPM need not be located within source 102 but rather may be located external to source 102. In one implementation, TPM 112 may provide certified key pair generation and/or storage following well known Public Key Infrastructure (PKI) and/or Wireless Public Key Infrastructure (WPKI) schemes as provided in International Telecommunication Union (ITU) Recommendation ITU-T X.509 (2000).

Moreover, the invention is not limited with regard to the specific architectural details of TPM 112 so long as TPM 112, or any means equivalent to TPM 112, can provide certified key pair generation and/or storage. In general, TPM 112 may comprise any appropriate combination of hardware, firmware and/or software capable of providing certified key pair generation and/or storage in accordance with the invention as disclosed herein. In one implementation, TPM generates key pairs and certifies those key pairs over network 110 using key certifier 108 following well known PKI and/or WPKI schemes as discussed below.

In one implementation, CSM 114 may include logic capable of capturing and/or receiving and/or obtaining image data, either directly from an embedded imaging array (not shown), for example, or indirectly from an imaging device (not shown) coupled to CSM 114 by a private network (not shown), for example. Overall, CSM 114 may comprise any appropriate combination of hardware, firmware and/or software capable of capturing and/or receiving and/or obtaining image data.

In one implementation, CSM 114 may sign one or more encoded messages utilizing well known Digital Signature Algorithm (DSA) schemes as provided in International Telecommunication Union (ITU) Recommendation ITU-T X.519 (2001) and embed those one or more signed and encoded messages in the image data. CSM 114 may comprise any appropriate combination of hardware, firmware and/or software capable of both signing a message and/or of embedding the signed message within the image data in accordance with the invention as described below. In one implementation, CSM 114 may sign messages using certified private keys obtained from TPM 112 as will be described in further detail below.

FIG. 2A illustrates an example implementation of CSM 114 including an image encoder 202, a message encoder 204, a sign module 206 and an embed module 208. CSM 114 may be capable of compressing (i.e., encoding) image data using image encoder 202, encoding a message using message encoder 204, signing the encoded message with a private key using sign module 206 and embedding the signed encoded message within the encoded image data using embed module 208 to generate signed image data. In one implementation, in addition to generating signed image data, embed module 208 may also generate image metadata specifying how and/or where the encoded message is embedded within the signed image data. In one implementation, verifier 104 may use the image metadata to extract the encoded message from the signed image data as will be described in more detail below.

Although FIGS. 1 and 2A show certain elements of system 100, such as image encoder 202 and/or message encoder 204 and/or embed module 208 as discrete devices, those of skill in the art will recognize that some elements of system 100 and/or CSM 114 may be implemented in various combinations of hardware, firmware and/or software without departing from the scope or spirit of the invention. For example, while FIG. 2A shows message encoder 204 as a discrete device, those of skill in the art will recognize that the function of encoder 204, as will be described in more detail below, may be provided by any suitable combination of hardware, firmware and/or software capable of encoding a message's audio and/or text data in accordance with the invention as described herein. Likewise, for example, those of skill in the art will recognize that the function of embed module 208, as will be described in more detail below, may be provided by any suitable combination of hardware, firmware and/or software capable of embedding an encoded message in accordance with the invention as described herein.

In one implementation, encoder 202 may be capable of compressing image data to generate encoded image data according to any of several image compression formats including, for example, compression formats promulgated by the Joint Photographic Expert Group (JPEG) and as provided in International Telecommunication Union (ITU) Recommendation ITU-T T.803 (“JPEG-2000”) (2000). In one implementation, message encoder 204 may capture or receive message data, compress or encode that message data using a CELP scheme, and then provide the encoded message to sign module 206. Sign module 206 may then utilize a well known digital signing scheme, such as DSA, to sign the compressed message with a private key of a certified key pair provided by TPM 112. Module 206 may then provide the signed message to embed module 208. In one implementation, as will also be described in more detail below, embed module 208 may then embed the signed encoded message in the encoded image data provided by image encoder 202 to generate signed image data. Embed module 208 may also generate image metadata specifying the manner in which the signed encoded message was embedded within the image data.

In one implementation, CSM 114 may associate the image metadata with the signed image data and provide at least the image metadata to verifier 104 over network 110. Thus, in one implementation, the image metadata may specify the identity and/or location of the signed image data as well as the manner in which the signed encoded message was embedded within the signed image data in order that verifier 104 may both locate the signed image data and extract the signed encoded message from the image data. Alternatively, in one implementation, CSM 114 may store the signed image data and/or the image metadata in image storage 106. Source 102 may then notify verifier 104 that signed image data is available in storage 106.

Referring again to FIG. 1, in one implementation, image verifier 104 may be an image verification and/or viewing system that permits a user and/or consumer and/or viewer of digital image data provided by image source 102 to ascertain the authenticity of that image data. Verifier 104 may do so by verifying the authenticity of the message signed and embedded within the image data by CSM 114. In one implementation, verifier 104 may verify the authenticity of the message signed and embedded within the image data by comparing the private key used to sign message with the associated public key of the key pair generated by and obtained from TPM 112 by requesting, over network 110, key certification from key certifier 108 using well known PKI and/or WPKI techniques.

In one implementation, verifier 104 may be a purchaser of signed images provided by source 102 and/or image storage 106 and/or certifier 108, although the invention is not limited in this regard. For example, in one implementation, verifier and/or purchaser 104 may obtain a signed image through another entity, such as a network-based retailer of signed images (not shown) coupled to network 110, where that entity has obtained the signed image data directly and/or indirectly from source 102 and/or storage 106 and/or certifier 108. In one implementation, verifier 104 may be a personal computing device, such as laptop computer, capable of communicating with network 110 and of obtaining signed image data from storage 106. Verifier 104 may also be capable of obtaining image metadata from source 102 and/or from storage 106 and of verifying the authenticity of signed messages embedded within the image data using a public key obtained from certifier 108.

FIG. 2B illustrates an example implementation of verifier 104. Verifier 104 may include masking logic 210 and a verification module 212. Masking logic 210 may use image metadata to determine where and/or how the signed encoded message was embedded in the signed image data. In response to logic 210, verification module 212 may extract the signed encoded message from the encoded image data and verify the authenticity of the extracted signed and encoded message using well known PKI and/or WPKI techniques in conjunction with a public key obtained from certifier 108.

Referring again to FIG. 1, network 110 may be a wireless local area network (WLAN) and/or wireless wide area network (WWAN) such as the global system for mobile communication (GSM) and/or wireless universal serial bus (wireless USB), to name a few examples. However, the invention is not limited in this regard and contemplates any wireless or non-wireless network capable of communicating and/or conveying signed image data, image metadata and/or keys amongst source 102, verifier 104, storage 106 and/or certifier 108 in keeping with the invention as disclosed herein.

Key certifier 108 may be any entity implementing key pair certification as provided by, for example, PKI and/or WPKI methodologies or schemes. For example, in one implementation, certifier 108 may issue and manage digital certificates associated with key pairs generated by TPM 112. In one implementation, for each key pair generated by TPM 112, certifier 108 generates a certificate including the public key of the key pair along with formation specifying, for example, the identity of the certificate holder (e.g. source 102 or the entity owning source 102) as well as information associating that certificate with specific signed image data.

Image storage 106 may be any storage device and/or set of storage devices capable of storing signed image data provided by source 102 over network 110. For example, in one implementation, storage 106 may comprise one or more storage servers linked to network 110, although the invention is not limited in this regard and storage 106 may comprise any combination of magnetic disk storage media, optical storage media, read only memory (ROM), random access memory (RAM), or flash memory devices, etc. capable of storing signed image data.

FIG. 3 is a flow chart illustrating a process 300 of authenticating image data in accordance with the invention. Although process 300, and associated processes, may be described with regard to system 100 of FIG. 1 and components of system 100 as illustrated in FIGS. 2A and 2B for ease of explanation, the claimed invention is not limited in this regard.

Process 300 may begin with the provision of image data [act 302]. In one implementation, source 102 captures an image using an imaging array (not shown) and provides the captured image data in act 302. Alternatively, source 102 may obtain the image data from a remote imaging device (not shown) coupled to source 102 by a private network (not shown). In one implementation the image data may be in a gray scale format, although the invention is not limited in this regard and other image formats, such as a three-component Red-Green-Blue (RGB) format may be used consistent with the invention as described herein.

The image data may then be encoded [act 304] using well known encoding techniques such as those recommended by JPEG-2000. One way to do this is by having image encoder 202 encode the image data by first segmenting the data into image blocks. For example, a 1024-by-1024 pixel gray scale image comprises 1,048,576 pixels which may be segmented into 16,384 contiguous 8-by-8 pixel image data blocks. Encoder 202 may then transform the image data blocks into the frequency domain using, for example, a Wavelet Packet Transform (WPT) scheme as recommended under the JPEG-2000 standard and quantize the transformed image data blocks to complete act 304.

Processing may continue with the capture of message data [act 306]. In one implementation, this may be accomplished by having source 102 capture message data. In one implementation, source 102 may capture message data comprising surround audio data captured by one or more microphones (not shown) associated with source 102. The message data may also include temporal and spatial location parameters associated with source 102 such as image capture time and/or date, image source location data (e.g., Global Positioning Signal (GPS) data specifying the physical location of source 102), etc. The captured message data may then be encoded [act 308]. In one implementation, after source 102 has captured the message data, message encoder 204 encodes the message using a CELP coding scheme.

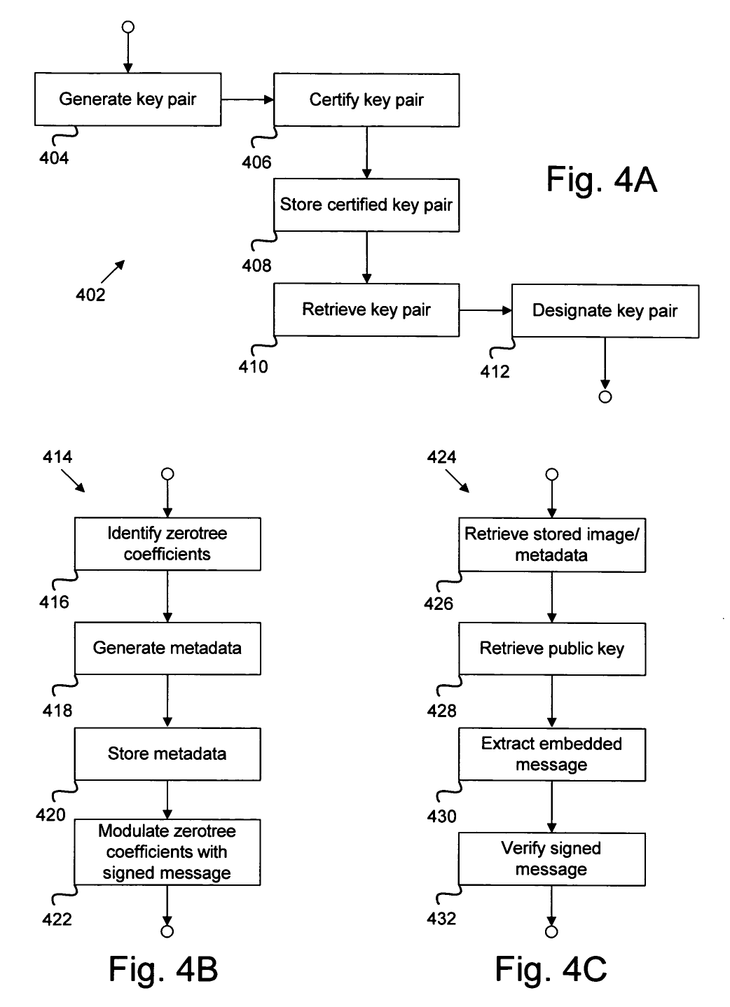

Once encoded, the message may be signed [act 310] using a private key of a certified key pair that may be provided in act 312. FIG. 4A is a flow chart illustrating a process 402 that may be implemented to provide a key pair [act 312]. Referring to both FIGS. 3 and 4A, process 402 may begin with the generation of one or more key pairs [act 404]. In one implementation, TPM 112 may generate a key pair using well known PKI and/or WPKI schemes. For example, TPM 112 may generate a random number, utilizing a random number generator (not shown), and use that random number to generate a key pair using well known DSA techniques, for example.

Those of skill in the art will recognize that TPM 112 may generate one or more key pairs and may store those key pairs at any time before the key pair is provided in act 312. In one implementation, TPM 112 may generate one or more key pairs upon, or subsequent to, the provision of image data in act 302. The invention is not limited in this regard, however, and any source of key pairs may generate a key pair in act 404. For example, one or more devices and/or entities external to source 102 and/or TPM 112, such as verifier 104 and/or certifier 108, could generate one or more key pairs in act 404.

Processing may continue with the certification and/or registration of one or more key pairs [act 406]. In one implementation, TPM 112 may register and/or certify a generated key pair [act 404] with key certifier 108 via network 110 using PKI and/or WPKI techniques. Those of skill in the art will recognize that TPM 112 may certify and/or register one or more key pairs at any time prior to message signing in act 310. In one implementation, TPM 112 may generate one or more key pairs and then certify those one or more key pairs upon, or subsequent to, the provision of image data in act 302. The invention is not limited in this regard, however, and device(s) other than TPM 112 and/or source 102 may certify and/or register one or more key pairs in act 406. For example, one or more devices and/or entities external to source 102 and/or TPM 112, such as verifier 104 and/or certifier 108, could certify and/or register one or more key pairs in act 406.

Certified and/or registered key pair(s) may be stored in act 408. In one implementation, TPM 112 may stored one or more certified and/or registered key pairs in memory (not shown) located within and/or associated with source 102 such as one or more registers and/or RAM and/or non-volatile memory (e.g., flash memory). In one implementation, TPM 112 may store the certified key pair as spare ink appropriate for use as digital signatures in a DSA scheme. The invention is not limited in this regard, however, and other devices and/or entities, such as verifier 104 and/or certifier 108 and/or CSM 114 and/or source 102, could store one or more certified key pairs. Moreover, the invention is not limited in this regard and, thus, in one implementation, verifier 104 may request a signed image from source 102 using an on-demand and/or real-time image certification scheme. For example, source 102 may sign and provide a certified image directly to verifier 104 without storing one or more certified key pairs.

Process 402 may continue with the retrieval of a certified key pair [act 410]. In one implementation, sign module 206 (FIG. 2A) of CSM 114 (FIG. 1) may retrieve a certified key pair stored in act 408. For example, sign module 206 may retrieve a certified key pair from memory (not shown), although the invention is not limited in this regard and another device, such as TPM 112, may provide sign module 206 with a certified key pair retrieved from memory. In one implementation, sign module 206 and/or CSM 114 may request a certified key pair from TPM 112 which may then retrieve a certified key pair from memory and provide that certified key pair to sign module 206 and/or CSM 114. Alternatively, in an on-demand and/or real-time image certification scheme, TPM 112 may generate a certified key pair and provide that key pair directly sign module 206 and/or CSM 114 without undertaking the act(s) of storing and/or retrieving that certified key pair.

Once a certified key pair is provided and/or retrieved from memory, the provided key pair may be designated as “used” [act 412]. In other words, to prevent re-use of a key pair provided in act 204, the certified key pair retrieved in act 410 may be labeled, flagged and/or otherwise designated as having been selected and/or provided to sign a message. In one implementation, once a certified key pair is provided to signing module 206, the device and/or entity that provided the key pair designates that key pair as having been used.

For example, in one implementation, TPM 112 may retrieve a certified key pair from memory in response to a request from sign module 206 and/or CSM 114. TPM 112 may then, upon or subsequent to providing that key pair to sign module 206 and/or CSM 114, designate the provided key pair as “used” by, for example, modifying a certified key pair status list. The invention is not limited in this regard, however, and this is only one possible scheme for keeping track of used and/or otherwise compromised key pairs. For example, in one implementation, TPM 112 may designate the provided key pair by setting and/or resetting one or more memory and/or register data bit(s) indicating clean and/or dirty key status for associated key pairs.

In another implementation, sign module 206 and/or CSM 114 may be provided with one or more key pairs prior to, for example, the capturing of message data [act 306], and may designate key pairs in act 412 by modifying a certified key pair status list. Obviously, many permutations of process 402 are possible and the invention is not limited, for example, with regard to which entity and/or device either retrieves the certified key pair in act 410 and/or designates that key pair in act 412.

Referring again to FIG. 3, once one or more certified key pairs are available, the signing of a message [act 310] may be implemented. Referring to FIG. 2A, this may be accomplished by having sign module 206 sign an encoded message encoded by message encoder 204 in act 308. In one implementation, sign module 206 may use the private key of the certified key pair provided in act 312 to sign the encoded message data using, for example, a DSA scheme. The invention is not limited in this regard however, and other signing algorithms capable of digitally signing the encoded message data may be utilized consistent with the invention as disclosed herein.

Process 300 may continue with serialization of the signed and encoded message data [act 314]. In one implementation, sign module may serialize the signed and encoded message data using well known serialization techniques although the invention is not limited in this regard and other entities and/or devices, such as a serialization module (not shown) associated with source 102, may provide for serialization in act 314.

Process 300 may continue with the embedding of the serialized, encoded and signed message data within and/or in the encoded image data [act 316] to generate signed image data. FIG. 4B is a flow chart illustrating a process 414 that may be implemented to embed the message data. Process 414 may begin with the identification of zerotree coefficients within the encoded image data [act 416] where zerotree coefficients may be defined as those frequency coefficients having zero value in the encoded image data. In one implementation, embed module 208 (FIG. 2B) may identify zerotree coefficients by searching the encoded image data for those image blocks that contain frequency coefficients having zero value. In one implementation, embed module 208 may identify a sufficient number of zero valued coefficients needed to match the size of the message to be embedded.

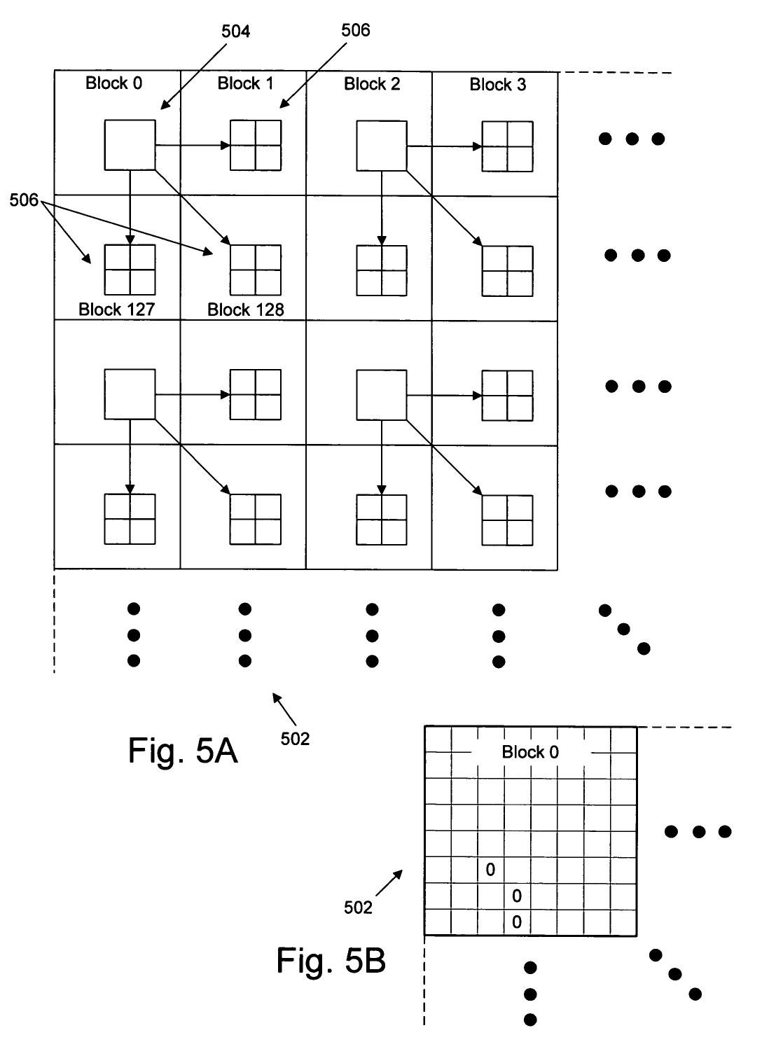

FIG. 5 illustrates a portion of an example array 502 representing encoded image data for a 1028-by-1028 pixel image segmented into a 128-by-128 array of 8-by-8 blocks of frequency coefficients. When transformed via act 304 into the frequency domain using WPT techniques, for example, coefficients within a given block, for example block 0, may be designated parent coefficients 504 while frequency coefficients in other blocks may be designated child coefficients 506. For example, parent coefficients in block 0 may be related to child coefficients in blocks 1, 127 and 128 according to WPT schemes. In one implementation, when undertaking act 416, embed module 208 may search an image data array, such as array 502, for frequency coefficients having zero value (i.e., zerotree coefficients). For example, FIG. 5B illustrates an example block 0 wherein module 208 might identify coefficients (2,6), (3,7) and (3,8) as having zero value.

Referring once again to FIG. 4B, process 414 may continue with the generation of image metadata [act 418]. In one implementation, embed module 208 may generate image metadata specifying at least the locations within array 502 of zerotree coefficients that have been or will be modulated to embed the encoded, signed and serialized message data as will be described below. Referring to FIG. 5B, image metadata for the image data represented by array 502 might include metadata specifying that coefficients (2,6), (3,7) and (3,8) have been or will be modulated to embed the message data. For example, metadata including 0/[(2,6), (3,7),(3,8)] may specify that coefficients (2,6), (3,7) and (3,8) of block 0 of the encoded image data contain the embedded message data. The image metadata generated in act 418 may be used to recover the message data from the signed image data as described in further detail below.

Referring again to FIG. 4B, process 414 may continue with the storage of image metadata [act 420]. This may be done by having embed module 208 and/or CSM 114 and/or source 102 store the image metadata generated in act 418 in image storage 106 in conjunction with the associated signed image data. Those of skill in the art will recognize that the image metadata may be stored before, contemporaneously with or after the associated signed image data may be stored as described below.

Process 414 may conclude with the modulation of the identified zerotree coefficients with the signed message [act 422]. In one implementation, embed module 208 may modulate those zerotree coefficients identified in act 416 with the serialized, signed and encoded message data provided in act 314 to generate signed image data.

Returning again to FIG. 3, process 300 may continue with the storage of the signed image data [act 318] where the image data being stored includes the message data embedded in act 316. In one implementation, source 102 and/or CSM 114 may store the signed image data in image storage 106 using network 110. Source 102 and/or CSM 114 may also inform verifier 104 that signed image data has been stored in act 318 as disclosed below, although the invention is not limited in this regard. For example, in one implementation, verifier 104 may request a signed and/or verified an/or certified image on-demand and/or in real-time from source 102 and source 102 may provide a signed and/or verified an/or certified image as signed image data to verifier 104 over network 110 without first storing that image.

Process 300 may continue with the authentication of the signed image data [act 320]. FIG. 4C is a flow chart illustrating a process 424 that may provide for authentication of signed image data. Process 424 may begin with the retrieval of stored image data and/or image metadata [act 426]. In one implementation, image verifier 104 may retrieve stored image data and/or image metadata from image storage 106 using network 110, although the invention is not limited in this regard and verifier 104 may, for example, retrieve stored image data from image storage 106 in response to associated image metadata provided by source 102.

Process 424 may continue with the retrieval of the public key of the key pair used to sign the image data [act 428]. In one implementation, verifier 104 may retrieve and/or obtain the public key from certifier 108 over network 110 using PKI and/or WPKI techniques.

Process 424 may continue with the extraction of the embedded signed message [act 430]. In one implementation, verifier may use the image metadata specifying modulated zerotree coefficients to extract the signed message from the encoded image data. In one implementation, masking logic 210 and verification module 212 (FIG. 2B) may be used to extract the signed message data. In one implementation, masking logic 210 may use the image metadata to identify those coefficients of the associated image data that have been modulated to embed the message data.

Once extracted, the signed message data may be verified [act 432]. In one implementation, verification module 212 may receive information from masking logic 210 identifying which coefficients contain the message data. For example, if the image metadata specifies that the message is embedded in coefficients (2,6), (3,7) and (3,8) of block 0, then logic 210 may inform module 212 of those coefficients. Verification module 212 may use the information supplied by logic 210 to extract the signed message data from the image data retrieved in act 426. Verification module 212 may then use the public key retrieved in act 428 to verify the authenticity of the signed message data using well known DSA verification techniques.

The acts shown in FIG. 3 and/or FIGS. 4A-C need not be implemented in the order shown; nor do all of the acts necessarily need to be performed. For example, the storage of image metadata [act 420] may occur before, during or after the modulation of zerotree coefficients in act 422. Also, those acts that are not dependent on other acts may be performed in parallel with the other acts. For example, the retrieval of stored image and or image metadata in act 426 may be undertaken in parallel with the retrieval of the associated public key [act 428]. Further, at least some of the acts in this figure may be implemented as instructions, or groups of instructions, implemented in a machine-readable medium.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention. For example, the apparatus, system and methods for authenticating images by digitally signing hidden messages near the time of capture is not limited to systems, apparatus or methods providing JPEG-compatible encoding or decoding. Rather, the claimed invention also contemplates other codec protocols capable of compressing image data in a manner that generates sufficient zero valued image coefficients to provide for the embedding of signed message data. Clearly, many other implementations may be employed to provide for authenticating images by digitally signing hidden messages near the time of capture consistent with the claimed invention.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method comprising:
providing one or more encoded image data blocks, the encoded image data blocks comprising frequency coefficients including zero valued frequency coefficients; and
embedding a message within at least one of the encoded image data blocks by modulating one or more zero valued frequency coefficients.

2. The method of claim 1, further comprising:
generating metadata, the metadata specifying at least one or more modulated zero value frequency coefficient.

3. The method of claim 1, wherein the message comprises at least encoded audio data and/or encoded text data.

4. The method of claim 3, wherein the message comprises at least audio data and/or text data encoded using a Codebook Excited Linear Predictor (CELP) scheme.

5. The method of claim 3, wherein the encoded text data comprises at least encoded data indicating one or more of time of image capture, date of image capture, and/or location of image capture.

6. The method of claim 1, wherein the encoded image data blocks comprise WPT image data blocks.

7. The method of claim 6, wherein the one or more zero valued frequency coefficients comprise one or more zerotree frequency coefficients.

8. The method of claim 1, wherein the message comprises a signed encoded message.

9. The method of claim 8, wherein the signed encoded message comprises an authenticated encoded message and/or a certified encoded message.

10. An apparatus comprising:
an image source capable of generating at least image data;
an encoder responsive to at least the image data, the encoder capable of generating one or more encoded image data blocks having one or more zero valued frequency coefficients; and
embedding logic responsive to at least the one or more encoded image data blocks, the embedding logic capable of at least embedding a message within the transformed image data blocks by modulating one or more zero valued frequency coefficients.

11. The apparatus of claim 10, wherein the embedding logic is further capable of generating metadata, the metadata specifying at least the one or more zero valued frequency coefficients modulated to embed the message.

12. The apparatus of claim 10, wherein the message comprises at least encoded audio data and/or encoded text data.

13. The apparatus of claim 12, wherein the message comprises at least audio data and/or text data encoded using a Codebook Excited Linear Predictor (CELP) scheme.

14. The apparatus of claim 12, wherein the encoded text data comprises at least encoded data indicating one or more of time of image capture, date of image capture, and/or location of image capture.

15. The apparatus of claim 10, wherein the encoded image data blocks comprise WPT image data blocks.

16. The apparatus of claim 15, wherein the one or more zero valued frequency coefficients comprise one or more zerotree frequency coefficients.

17. The apparatus of claim 10, wherein the message comprises a signed encoded message.

18. The apparatus of claim 17, wherein the signed encoded message comprises an authenticated encoded message and/or a certified encoded message.

19. A system, comprising:
an image data source, the image data source capable of providing image data; and
processing logic responsive to the image data, the processing logic capable of at least the following:
quantizing transformed image data blocks to generate one or more encoded image data blocks, the encoded image data blocks comprising frequency coefficients including one or more zero valued frequency coefficients; and
embedding a message within at least one of the encoded image data blocks by modulating at least one zero valued frequency coefficient.

20. The system of claim 19, wherein the encoded image data blocks comprise WPT image data blocks and wherein the one or more zero valued frequency coefficient comprise one or more zerotree frequency coefficients.

21. The system of claim 19, the processing logic further capable of generating metadata, the metadata specifying at least one zero valued frequency coefficient modulated to embed the message.

22. The system of claim 19, wherein the message comprises at least encoded audio data and/or encoded text data.

23. The system of claim 22, wherein the encoded text data comprises at least encoded data indicating one or more of time of image capture, date of image capture, and/or location of image capture.

24. The system of claim 19, wherein the message comprises a signed encoded message.

25. The system of claim 24, wherein the signed encoded message comprises an authenticated encoded message and/or a certified encoded message.

26. An article comprising a machine-accessible medium having stored thereon instructions that, when executed by a machine, cause the machine to:
provide one or more encoded image data blocks, the encoded image data blocks comprising frequency coefficients including one or more zero valued frequency coefficients; and
embed a message within at least one of the encoded image data blocks by modulating at least one zero valued frequency coefficient.

27. The article of claim 26, wherein the instructions, when executed by a machine, further cause the machine to:
generate metadata, the metadata specifying one or more zero valued frequency coefficients modulated to embed the message.

28. The article of claim 26, wherein the message comprises at least encoded audio data and/or encoded text data.

29. The article of claim 28, wherein the encoded text data comprises at least encoded data indicating one or more of time of image capture, date of image capture, and/or location of image capture.

30. The article of claim 26, wherein the encoded image data blocks comprise WPT image data blocks and wherein the zero valued frequency coefficients comprise one or more zerotree frequency coefficients.

31. The article of claim 26, wherein the message comprises a signed encoded message.

32. The article of claim 31, wherein the signed encoded message comprises an authenticated encoded message and/or a certified encoded message.
